(19) United States
(12) Patent Application Publication
(10) Pub. No.: US 2006/0068199 A1
(43) Pub. Date: Mar. 30, 2006

(54) Decal and method for treating surfaces

(76) Inventors: David W. Koenig, Menasha, WI (US); Fung-jou Chen, Appleton, WI (US); Michael S. Brunner, Roswell, GA (US); James McManus, Hortonville, WI (US); Mary Holt, Fremont, WI (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/957,494

(22) Filed: Sep. 30, 2004

(51) Int. Cl. B32B 7/12

(52) U.S. Cl. 428/343; 428/40.1

(57) ABSTRACT

In one example form, the present invention relates to a decal for treating a surface. The decal includes a web and an agent for treating the surface. The agent is attached to the web. The decal further includes a bonding material that attaches the decal to the surface. The bonding material is also attached to the web. In some embodiments, the agent may be attached to the web while in other embodiments the agent may form part of the web. In addition, the agent may be at least partially, or wholly, soluble in the web, or may be suspended in the web. In another form, the present invention relates to a method of treating a surface. The method includes attaching a decal to the surface and treating the surface with the decal. Attaching a decal to the surface may include adhering the decal to the surface with an adhesive.

### FIELD OF THE INVENTION

This invention relates to surface treatment, and in particular to a decal and method for treating surfaces.

### BACKGROUND OF THE INVENTION

There are a variety of items that are used to treat household surfaces (e.g., kitchen, bath and basement surfaces). The items are typically in granulated, powdered, solid or liquid form.

One drawback with using liquids to treat surfaces is that they are heavy and bulky making them difficult to manipulate and transport. Liquids are also easily spilled as they are stored for shipment, or placed onto a surface that needs treating.

One of the drawbacks associated with using powdered and/or granulated items to treat surfaces is that they are difficult to measure and/or dispense. In addition, the powdered or granulated items are usually messy and when inhaled may pose a potential health hazard.

One type of surface treatment includes treating surfaces for mildew, which is commonly associated with the growth of molds on many types of surfaces. Most of the mold and “mildew” found on bath and kitchen surfaces causes aesthetic problems on the surfaces. Some of the example molds that cause aesthetic problems on such surfaces include Zygomycetes (e.g., Cladosporium, Dresclera, Penicillum Altemaria, Epicoccum, Pithomyces, Stemphydium, Ulocladium, Aureobasidium, Altemaria, Stachybotrys and Memnoniella).

There are some types of molds that are black molds which can generate critical health issues. Black molds are typically treated with anti-fungal compounds. The most common black molds include Cladosporium, Ulocladium, Stemphylium, Pitomyces, Altemaria, Dresclera, and Aureobasium.

There are some black molds that produce a potentially hazardous substance called mycotoxin. Some of the common mycotoxin producing black molds include Aspergillus, Stachybotrys, and Memnoniella.

### SUMMARY OF THE INVENTION

This invention provides a convenient and cost-effective decal and method for treating surfaces. The decal and method may use a controlled release agent to keep surfaces clean between manual cleanings. As an example, the decal and method may provide protection to a surface (e.g., bath, kitchen, or basement surface) by killing fungi on the surface and/or preventing mold, mildew, and bacteria from growing on the surface.

The present invention relates to a decal for treating a surface. The decal includes a web and an agent for treating the surface. The agent is attached to the web. The decal further includes a bonding material that attaches the decal to the surface. The bonding material is also attached to the web.

In some embodiments, the agent may be attached to the web while in other embodiments the agent may form part of the web. In addition, the agent may be at least partially, or wholly, soluble in the web, or may be suspended in the web.

In some embodiments, the bonding material may be attached to the web and/or agent while in other embodiments the bonding material my form part of the web and/or agent. In embodiments where the bonding material forms part of the web and/or agent, the bonding material may be suspended in the web and/or agent, or soluble in the web and/or agent.

In another form, the decal includes a web and an agent for treating the surface. The agent is incorporated into the web. The web is tacky enough such that the web is able to adhere the decal to the surface. The agent may be at least partially, or wholly, soluble in the web, or the agent may be suspended in the web.

In another form, the present invention relates to a method of treating a surface. The method includes attaching a decal to the surface and treating the surface with the decal.

In some embodiments, attaching a decal to the surface may include adhering the decal to the surface with an adhesive. In addition, adhering the decal to the surface with an adhesive may include removing a cover from the adhesive.

There are some embodiments where treating the surface with the decal may include activating an agent that forms part of the decal. In addition, activating an agent that forms part of the decal may include exposing the decal to moisture. It should be noted that treating the surface with the decal may also include dissolving the decal with water and/or removing fungus from the surface.

### BRIEF DESCRIPTION OF THE DRAWINGS

FIG. 1 is a perspective view illustrating an example decal for treating a surface when the decal is attached to the surface.

FIG. 2 is a section of view of the decal shown in FIG. 1 taken along line 2-2.

FIG. 3 is a section view similar to FIG. 2 illustrating another example decal for treating a surface.

FIG. 4 is a section view similar to FIGS. 2-3 illustrating another example decal for treating a surface.

FIG. 5 is a section view similar to FIGS. 2-4 illustrating another example decal for treating a surface.

FIG. 6 is a section view similar to FIGS. 2-5 illustrating another example decal for treating a surface.

FIG. 7 is a section view illustrating another example decal for treating a surface.

FIG. 8 is a section view similar to FIG. 7 illustrating another example decal for treating a surface.

FIG. 9 is a flow diagram illustrating a method of treating a surface.

FIG. 10 is a plan view illustrating another example decal for treating a surface

### DESCRIPTION OF THE INVENTION

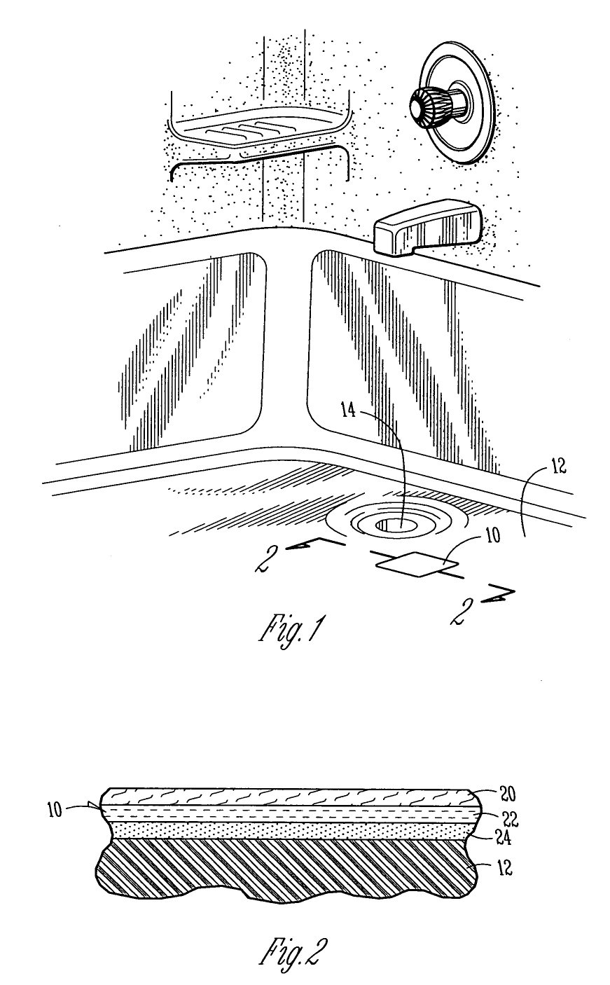

FIG. 1 illustrates a decal 10 for treating a surface 12. Although the decal 10 is shown in FIG. 1 as treating a surface 12 near a drain 14, it should be noted that the decal 10 may be used to treat any surface (e.g., kitchen, bath and basement surfaces). In addition, the decal 10 may be placed on any vertical or horizontal surface.

As shown in FIGS. 2-4, the decal 10 includes a web 20 and an agent 22 for treating the surface 12. The decal 10 further includes a bonding material 24 that is attached the web 20. The bonding material 24 is used to attach the decal 10 to the surface 12.

The agent 22 is attached to (FIG. 2), or made part of (FIGS. 3 and 4), the web 20 through any method known now or discovered in the future. As used herein, “web” refers to any type of substrate including laminates of one or more types of material. The web 20 may include any type of layer or material, such as films of thermoplastic material, a non-woven web of thermoplastic material or a combination of thermoplastic material and natural fibers such as wood pulp fluff fibers, woven webs made of strands of thermoplastic material, natural material such as threads of cotton and the like, polymers, waxes or combinations thereof. The web 20 may also be formed of multiple layers of materials.

In the example embodiment illustrated in FIG. 2, the web 20 and agent 22 are formed as separate layers that are joined together. FIGS. 3 and 4 show that the agent 22 may also be incorporated into web 20. FIG. 3 shows that the agent 22 may be at least partially, or wholly, soluble in the web 20, while FIG. 4 shows that the agent may be suspended in the web 20. A range of materials can be used to hold the agent 22 and/or form the web 20 such that the agent 22 is released over time. These materials may include one or more thermoplastics, organic polymers (e.g., natural polysaccharides), starches, gums, alginate and xanthan (among other materials). The quantity of agent 22 in the decal 10 will be based on the properties that are desired within particular commercial products.

In the example embodiment illustrated in FIG. 2, web 20, agent 22 and bonding material 24 are formed as separate layers. Although web 20, agent 22 and bonding material 24 are shown as layers of the same size, it should be noted that the layers may be different sizes and/or shapes.

In other embodiments, agent 22 may be stored in a reservoir layer when the agent 22 is part a laminate structure. The laminate structure may include a rate limiting layer that releases the agent 22 over time.

The agent 22 may also be placed in a porous material (e.g., foam) that releases agent 22 over time. The release rate of the agent 22 will be determined in part by the nature of the porous material and the form of the agent 22 (i.e., liquid, powder or solid).

In alternative embodiments, the agent 22 may be incorporated into a substance that dissolves away over time as the decal 10 is exposed to moisture (e.g., water). Therefore, as the substance dissolves, the agent 22 may be released.

In some sample forms, the agent 22 may include an anti-fungal agent or some other biocide. A wide array of anti-fungal agents may be used in the decal 10. The anti-fungal agents may range anywhere from simple metals and chemicals to complex proteins and bio-compounds. As discussed above, anti-fungal agent 22 may be incorporated into the decal 10 when the web 20 is a polymer matrix such that anti-fungal agent 22 is released over time.

Some example anti-fungal agents include vinegar, borax, copper, 2-n-octyl-4-isothiazolin-3-one, grape oil, sunflower seed oil, chitinase E (family 19; class IV), grapefruit extract, indole alkaloid venenatine, silicon-containing derivatives of 2-aryl-3-(1H-1,2,4-triazol-1-yl)propanenltriles, o-carboranylalanine, and Polyphase CST (i.e., a non-metallic, water-dispersible liquid fungicide/mildewcide).

Other example anti-fungal agents include chlorine and chlorine compounds (e.g., sodium hypochlorite), iodine and iodine compounds, other halogen and halogen compounds (e.g., bromine), alcohols (e.g., IPA, ETOH, methanol), oxidants (e.g., hydrogen peroxide, peracetic acid), nitrogen compounds (e.g., thiazoles, mercatobenzothiazole, quinolines, anilides), quaternary ammonium compounds (e.g., benzalkonium chloride), phenolics (hydroxybenoic acid, chloroxylenol), acid-anionic compounds (e.g., alky aryl sulfonates) and organic acids (e.g., propionic, benzoic, lactic, citric, sorbic).

It should be noted that the anti-fungal agent 22 may be any type of anti-fungal agent. Some additional example anti-fungal agents 22 include organic and inorganic mercurials, silver and silver compounds, other heavy metals (e.g., zinc, copper, nickel), cationic bisguanide, tryclosan, isothiazolin, chlorinated phenoxy, carbamates, 2-Dibromo-3-nitrilopropionamide, and a variety of natural compounds (e.g., terpene and aliphatic compounds).

When the agent 22 includes one or more biocides, the antimicrobial activity of the biocides is dependant on several factors including time of exposure, concentration, temperature, pH, and the presence of ions and organic matter. In addition, the physical and/or chemical nature of the surface to be treated (e.g., disinfected) may be important due to the interactions that may happen between the surface and any agents. Other important factors that affect the performance of anti-fungal agents include the physiological state and population size of any microbes that are to be treated on a surface.

Each of the aforementioned factors may be influenced by both the formulation of one or more of the anti-fungal agents and the environmental conditions under which the agents are applied to the surface. In addition, there may also be hydrophobic/hydrophilic interactions and/or stearic properties that affect the performance of an anti-fungal agent.

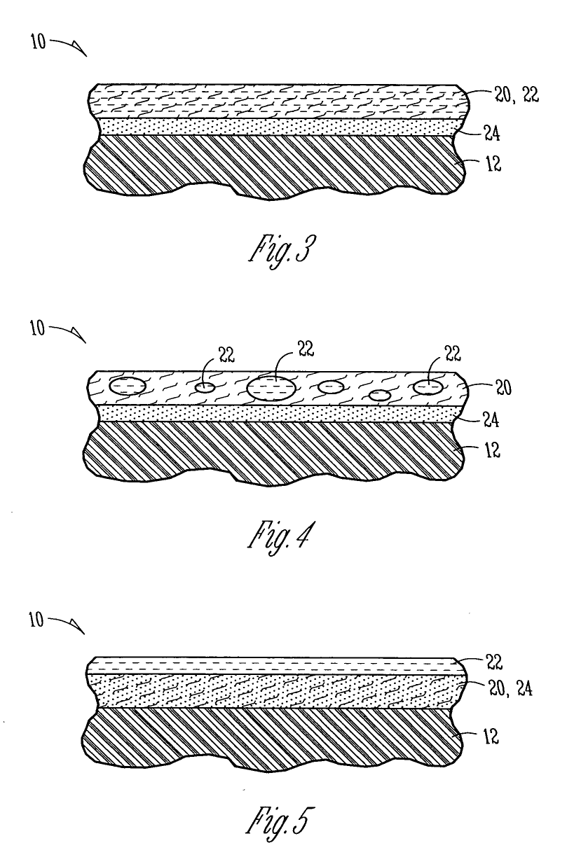

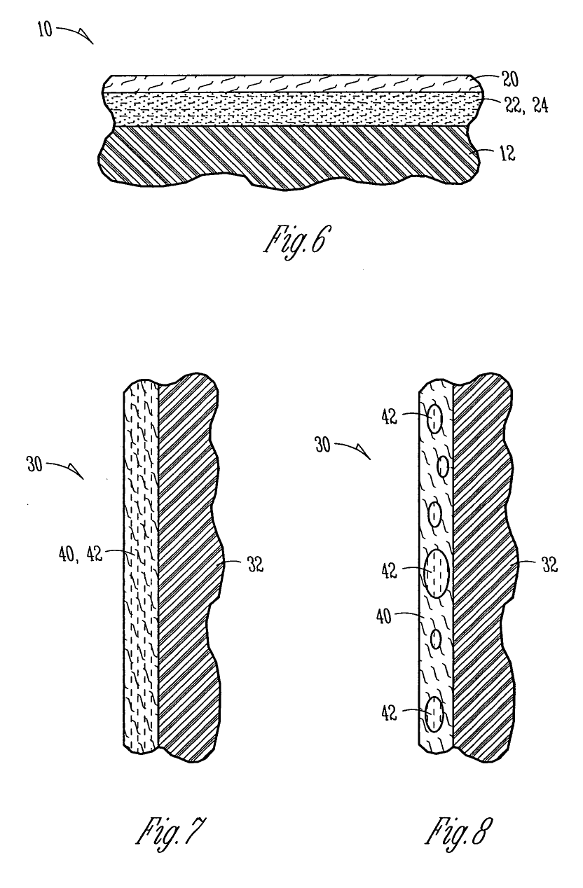

As discussed above, the decal 10 further includes a bonding material 24 that attaches the decal 10 to the surface 12. The bonding material 24 may be attached to the web 20 and/or agent 22 (FIG. 2), or made part of the web 20 (FIG. 5) or agent 22 (FIG. 6), through any method known now or discovered in the future.

In the example embodiment illustrated in FIG. 2, the bonding material 24 is in the form of an adhesive layer that is attached to the web 20 and agent 22. The backside of the decal 10 is readily attached to the surface 12 by adhering the adhesive layer to the surface 12.

In some embodiments, the adhesive layer attaches the decal 10 to the surface 12 until the decal 10 is peeled off so that no adhesive or residue is left behind on the surface 12. The quantity and type of bonding material 24 in the decal 10 will be based on the properties that are desired within particular commercial products.

In the example embodiment illustrated in FIG. 2, the web 20, agent 22 and bonding material 24 are formed as separate layers that are joined together. Although the web 20, agent 22 and bonding material 24 are shown as layers of the same size, it should be noted that the layers may be different sizes and or shapes.

As discussed above, the agent bonding material 24 may be separate from the web 20 and agent 22 (FIG. 2), or form part of the web 20 (FIG. 5) or agent 22 (FIG. 6). In embodiments where the bonding material forms part of the web 20 and/or agent 22, the bonding material 24 may be (i) suspended in the web 20 and/or agent 22; or (ii) soluble in the web 20 and/or agent 22.

In embodiments where the bonding material 24 is separate from the web 20 and the agent 22, the bonding material 24 may dissolve away over time as the decal 10 is exposed to moisture (e.g., water). In other embodiments where the bonding material 24 forms part of the web 20 or agent 22, the bonding material 24 may dissolve away over time along with the web 20 and/or agent 22.

Some example materials that may be used for the bonding material 24 include pressure-sensitive adhesives (PSAs), hotmelt adhesives, reactive adhesives (e.g., isocyanates, cyanoacrylates, acrylics, ethylvinylacetates), latex adhesives and epoxies. The type of bonding material 24 will be selected based on processing parameters, solubility and whether the bonding material forms part of the web 20 and/or agent 22 (among other factors).

Other example adhesives that may be used for the bonding material 24 include EVA (ethylene vinyl acetate) hotmelts (e.g., copolymers of EVA), polyolefin hotmelts, polyamide hotmelts, pressure sensitive hot melts, styrene-isoprene-styrene (SIS) copolymers, styrene-butadiene-styrene (SBS) copolymers; ethylene ethyl acrylate copolymers (EEA); polyurethane reactive (PUR) hotmelts, and poly(alkyloxazoline) hotmelt compounds (among others). Some specific examples of adhesives that may be suitable for some embodiments include (i) SUNOCO CP-1500 (an isotactic polypropylene) of Sunoco Chemicals (Philadelphia, Pa.); (ii) Eastman C10, Eastman C18, and Eastman P1010 (an amorphous polypropylene) of Eastman Chemical (Longview, Tex.); (iii) Findley H1296 and Findley H2525A of Elf Atochem North America (Philadelphia, Pa.); (iv) HM-0727, HM-2835Y, and 8151-XZP of H.B. Fuller Company (St. Paul, Minn.); and (v) National Starch 34-1214 made by National Starch and Chemical Corp. (Berkeley, Calif.).

The decal 10 may further include other ingredients, such as brighteners, soil anti-redeposit ion agents, color preservatives, stain removal enzymes, metal chelating agents, water hardness adjusting agents, dyes, perfumes and combinations thereof. In some forms, functional groups, or ethoxylation and/or propoxylation, can be included in the decal 10 to increase solubility in aqueous solutions. The decal 10 may also include an additional odor control ingredient (e.g., nanoparticulates) to reduce odors near the surface 12.

The decal 10 may also include pH adjusting agents that are released at a slow rate to raise or lower the pH of water that engages the surface 12. The pH of the water may be manipulated to optimize enzyme and stain removal performance.

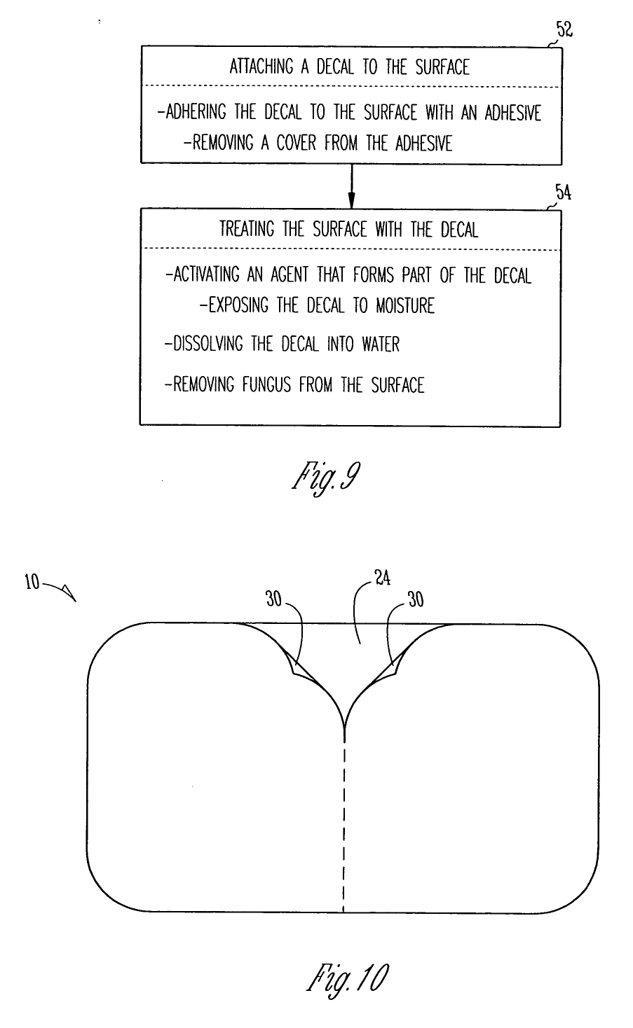

FIGS. 7 and 8 illustrate another example decal 30 for treating a surface 32. The decal 30 includes a web 40 and an agent 42 for treating the surface 32. The agent 42 is incorporated into the web 40. The web 40 is tacky enough such that the web 40 is able to adhere the decal 30 to the surface 32. FIG. 7 shows that the agent 42 may be at least partially, or wholly, soluble in the web 40, while FIG. 8 shows that the agent 42 may be suspended in the web 40.

The agent 42 may be made part of the web 40 through any method known now or discovered in the future. The web 40 may include any type of layer or material, such as films of thermoplastic material, as long as the web 40 is able to adhere the decal 30 to a surface 32. The web 40 may also be formed of multiple layers of materials.

As discussed above, a range of materials can be used to hold the agent 42 and/or form the web 40 such that the agent 42 is released over time. The quantity of agent 42 in the decal 30 will be based on the properties that are desired within particular commercial products.

FIG. 9 illustrates a method 50 method of treating a surface. The method 50 includes attaching a decal to the surface 52 and treating the surface with the decal 54.

In some forms of the method, attaching a decal to the surface 52 may include adhering the decal to the surface with an adhesive. In addition, adhering the decal to the surface with an adhesive may include removing a cover 30 from the adhesive (see, e.g., cover 30 in FIG. 10).

Treating the surface with the decal 54 may include activating an agent that forms part of the decal. In addition, activating an agent that forms part of the decal may include exposing the decal to moisture. It should be noted that treating the surface with the decal 54 may also include (i) dissolving the decal into water; and/or (ii) reducing fungus on the surface.

As part of fabricating decal 10, multiple decals may be cut from a sheet that is feed out from a continuous roll. The multiple decals may then be stacked for packaging or delivered as the continuous roll. In some forms, multiple decals may be inter-folded, o-folded and/or compressed into various geometric shapes. In addition, when the decals are stacked, the decals may be separated by a substrate that serves as a barrier between the decals. In addition, the decal 10 may be embossed with logos, use instructions or any other design or information.

It should be noted that one or more of the web 20, agent 22 and bonding material 24 may be partially, or wholly, soluble in a liquid (e.g., water) such that one or more of the web 20, agent 22 and bonding material 24 are readily dissolved when the decal 10 is exposed to water. The type of web 20, agent 22 and bonding material 24 will be selected based on (i) processing parameters; (ii) dispensing characteristics; (iii) packaging issues; and (iv) solubility.

In addition, the web 20, agent 22 and bonding material 24 should have the properties that are required for a particular product and/or process (e.g., disinfectant, descaler, sanitizer, detergent, cleanser and combinations thereof). The web 20, agent 22 and bonding material 24 properties may be controlled to define properties such as melting temperature, shear strength, viscosity, crystallinity, solid phase matrix, hardness, tackiness and heat stability (among other properties).

It should be noted that one or more decals 10 may applied to target areas on a surface in a geometric or random pattern. In addition, the decals 10 may be in any form or shape that treats a particular area on a surface. As an example, the decal 10 may be in the form of a continuous strip. The decal 10 may also be decorative in color and/or shape depending on consumer appeal.

There are also embodiments that are contemplated where the decal 10 has a clear and/or unobtrusive product form such that the decal 10 discreet and does not interfere with the aesthetics of the room where the surface 12 is located. In addition, the decal 10 may include an indicator (e.g., a section that changes color) that provides information as to when the decal 10 is out of agent 22 and requires replacement.

While the invention has been described in detail with respect to specific embodiments, it will be appreciated that there are variations of, and equivalents to these embodiments. Accordingly, the scope of the present invention should be determined by the appended claims and any equivalents thereto.

What is claimed is:

1. A decal for treating a surface, the decal comprising:
a web;
an agent for treating the surface, the agent being attached to the web; and
a bonding material that attaches the decal to the surface, the bonding material being attached to the web.

2. The decal of claim 1 wherein the agent treats the surface when the decal is exposed to moisture.

3. The decal of claim 1 wherein the web is a polymer matrix.

4. The decal of claim 1 wherein the agent is an anti-fungal agent.

5. The decal of claim 1 wherein the bonding material is an adhesive, and the decal further comprises a cover attached to the adhesive.

6. The decal of claim 5, wherein the cover is removable to expose the adhesive.

7. The decal of claim 1 wherein the web dissolves in water.

8. The decal of claim 1 wherein the bonding material dissolves in water.

9. The decal of claim 1 wherein the agent dissolves in water.

10. The decal of claim 1 wherein the agent is suspended in the web.

11. The decal of claim 1 wherein the agent is at least partially soluble in the web.

12. The decal of claim 1 wherein the bonding material is suspended in the web.

13. The decal of claim 1 wherein the bonding material is at least partially soluble in the web.

14. The decal of claim 1 wherein the bonding material is a layer covering a portion of at least one of the web and the agent.

15. The decal of claim 1 further comprising an indicator that provides information as to when the decal is out of agent.

16. The decal of claim 1 wherein the agent is a PH adjusting agent.

17. A method of treating a surface, the method comprising:
attaching a decal to the surface; and
treating the surface with the decal.

18. The method of claim 17 wherein attaching a decal to the surface includes adhering the decal to the surface with an adhesive.

19. The method of claim 18 wherein adhering the decal to the surface with an adhesive includes removing a cover from the adhesive.

20. The method of claim 17 wherein treating the surface with the decal includes activating an agent that forms part of the decal.

21. The method of claim 20 wherein activating an agent that forms part of the decal includes exposing the decal to moisture.

22. The method of claim 17 wherein treating the surface with the decal includes dissolving at least a portion of the decal into water.

23. The method of claim 17 wherein treating the surface with the decal includes removing fungus from the surface.

24. A decal for treating a surface, the decal comprising:
a web;
an anti-fungal agent attached to the web; and
an adhesive layer covering a portion of at least one of the web and the agent, the adhesive layer attaching the decal to the surface.

25. The decal of claim 24 wherein the anti-fungal agent reduces fungus on the surface when the decal is exposed to moisture.

26. The decal of claim 24 further comprising a cover attached to the adhesive, the cover being removable to expose the adhesive.

27. The decal of claim 24 wherein the anti-fungal agent dissolves in water.

28. The decal of claim 24 wherein the web dissolves in water.

29. A decal for treating a surface, the decal comprising:
a web that includes an agent for treating the surface, the web being tacky enough such that the web adheres to the surface.

30. The decal of claim 29 wherein the agent treats the surface when the decal is exposed to moisture.

31. The decal of claim 29 wherein the agent is an anti-fungal agent.

32. The decal of claim 29 wherein the web dissolves in water.

33. The decal of claim 29 wherein the agent is suspended in the web.

34. The decal of claim 29 further comprising an indicator that provides information as to when the decal is out of agent.

35. The decal of claim 29 wherein the agent is a PH adjusting agent.
